(19) United States
(12) Patent Application Publication
(10) Pub. No.: US 2016/0103707 A1
(43) Pub. Date: Apr. 14, 2016

(54) System and Method for System on a Chip

(71) Applicant: Futurewei Technologies, Inc., Plano, TX (US)

(72) Inventors: Debashis Bhattacharya, Plano, TX (US); Alan Gatherer, Richardson, TX (US); Ashish Rai Shrivastava, Plano, TX (US); Mark Brown, Little Elm, TX (US); Zhenguo Gu, Plano, TX (US); Qiang Wang, San Jose, CA (US); Alex Elisa Chandra, Plano, TX (US)

(21) Appl. No.: 14/877,155

(22) Filed: Oct. 7, 2015

Related U.S. Application Data
(60) Provisional application No. 62/062,374, filed on Oct. 10, 2014.

(51) Int. Cl. G06F 9/48; G06F 9/445

(52) U.S. Cl. CPC G06F 9/4881; G06F 9/44505

(57) ABSTRACT

A method includes receiving, by a system on a chip (SoC) from a logically centralized controller, configuration information and reading, from a semantics aware storage module of the SoC, a data block in accordance with the configuration information. The method also includes performing scheduling to produce a schedule in accordance with the configuration information and writing the data block to an input data queue in accordance with the schedule to produce a stored data block. Additionally, the method includes writing a tag to an input tag queue to produce a stored tag, where the tag corresponds to the data block.

This application claims the benefit of U.S. Provisional Application Ser. No. 62/062,374 filed on Oct. 10, 2014, and entitled “System and Method for a Software Defined Network (SDN)-like Radio Access Network System on a Chip Architecture Utilizing Automatic Datapath Blocks,” which application is hereby incorporated herein by reference.

### TECHNICAL FIELD

The present invention relates to a system and method for a wireless communications, and, in particular, to a system and method for system on a chip (SoC).

### BACKGROUND

Radio access network (RAN) system on a chip (SoC) architectures, or baseband processing architectures, may suffer from high system control overhead. RAN SoC architectures may also suffer from divergent use models for programmable compute engines, such as digital signal processors (DSPs) and central processing units (CPUs), and non-programmable compute engines, such as hardware accelerator architectures (HACs). This may make programmable compute engines and non-programmable compute engines problematic to integrate. There may be a bottleneck in how work is split between programmable compute modules and non-programmable compute modules. The design of a system with DSPs and HACs may lead to fewer, power hungry, complex DSPs with little system parallelism, and complex system level control code.

### SUMMARY

An embodiment method includes receiving, by a system on a chip (SoC) from a logically centralized controller, configuration information and reading, from a semantics aware storage module of the SoC, a data block in accordance with the configuration information. The method also includes performing scheduling to produce a schedule in accordance with the configuration information and writing the data block to an input data queue in accordance with the schedule to produce a stored data block. Additionally, the method includes writing a tag to an input tag queue to produce a stored tag, where the tag corresponds to the data block.

An embodiment method includes receiving, by a logically centralized controller from a system compilation infrastructure, compiled instructions and determining configuration information in accordance with the compiled instructions. The method also includes transmitting, by the logically centralized controller to a system on a chip (SoC), the configuration information and receiving, by the logically centralized controller, from the SoC, feedback in accordance with the configuration information.

An embodiment system includes a data storage module, a processor coupled to the data storage module, and a non-transitory computer readable storage medium storing programming for execution by the processor. The programming includes instructions to receive a first data block from a first compute engine and determine a first tag corresponding to the first data block. The programming also includes instructions to write the first data block to the data storage module in accordance with the first tag and write the first tag to the data storage module.

An embodiment logically centralized controller includes a processor and a non-transitory computer readable storage medium storing programming for execution by the processor. The programming includes instructions to receive, from a system compilation infrastructure, compiled instructions and determine configuration information in accordance with the compiled instructions and transmit, to a system on a chip (SoC), the configuration information. The programming also includes instructions to receive, from the SoC, feedback in accordance with the configuration information.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of a wireless network for communicating data;

FIG. 2 illustrates an embodiment system on a chip (SoC) architecture;

FIG. 3 illustrates another embodiment SoC architecture;

FIG. 4 illustrates an embodiment data storage module;

FIG. 5 illustrates an embodiment on-the-fly data reorganization;

FIG. 6 illustrates another embodiment on-the fly data reorganization;

FIG. 7 illustrates an embodiment subcarrier processing;

FIG. 8 illustrates an embodiment semantics aware data reorganization;

FIG. 9 illustrates another embodiment semantics aware data reorganization;

FIG. 10 illustrates a flowchart of an embodiment method of SoC data storage performed by a controller;

FIG. 11 illustrates a flowchart of an embodiment method of semantics aware data storage performed by an SoC;

FIG. 12 illustrates a flowchart of an embodiment method of SoC data storage performed by a data storage module;

FIG. 13 illustrates a block diagram of an embodiment processing system; and

FIG. 14 illustrates a block diagram of an embodiment a transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or not. The disclosure should in no way be limited to the illustrative implementations, drawings, and techniques illustrated below, including the exemplary designs and implementations illustrated and described herein, but may be modified within the scope of the appended claims along with their full scope of equivalents.

For the purpose of clarity, the concepts of memory and storage will be discussed briefly. The descriptions of memory and storage should be construed consistent with the understanding of one who is skilled in the art. Memory is generally considered to be a physical construct with no inherent awareness of what is stored in it. Memory may be used by multiple different software applications for storage of data. On the other hand, storage is associated with metadata, such as indicators, pointers, labels, etc., that may provide context for the storage, such as the relationships between information stored at different memory addresses.

In some systems that utilize system on a chip (SoC) technology, data that is not going to be used for a while may be stored off-chip in double data rate (DDR) memory or when masters attempt to store data into a shared on-chip memory. The data interface to DDR memory may be a bottleneck. Also, in some systems, many masters on the SoC drive access to the DDR memory, which acts as a slave component to different masters. Examples of DDR memory include, but are not limited to double data rate type three synchronous dynamic random access memory (“DDR3”), double data rate fourth generation synchronous dynamic random access memory (“DDR4”), and double data rate type five synchronous graphics random access memory (“GDDR5”). It is explicitly understood that other types of high bandwidth memory could be used in conjunction with the present disclosure.

There may be a large number of different intellectual property (IP) blocks with software components, hardware components, or both, that access the DDR memory. In some systems, these IP blocks do not work together to have a coordinated access scheme. Each IP block carves out oversized sections of the DDR memory, which leads to unused or inefficiently used memory. Also, the pattern in which the IP blocks access memory may be uncoordinated, and may lead to bursts of heavy data access and periods of no access. This may lead to inefficiencies.

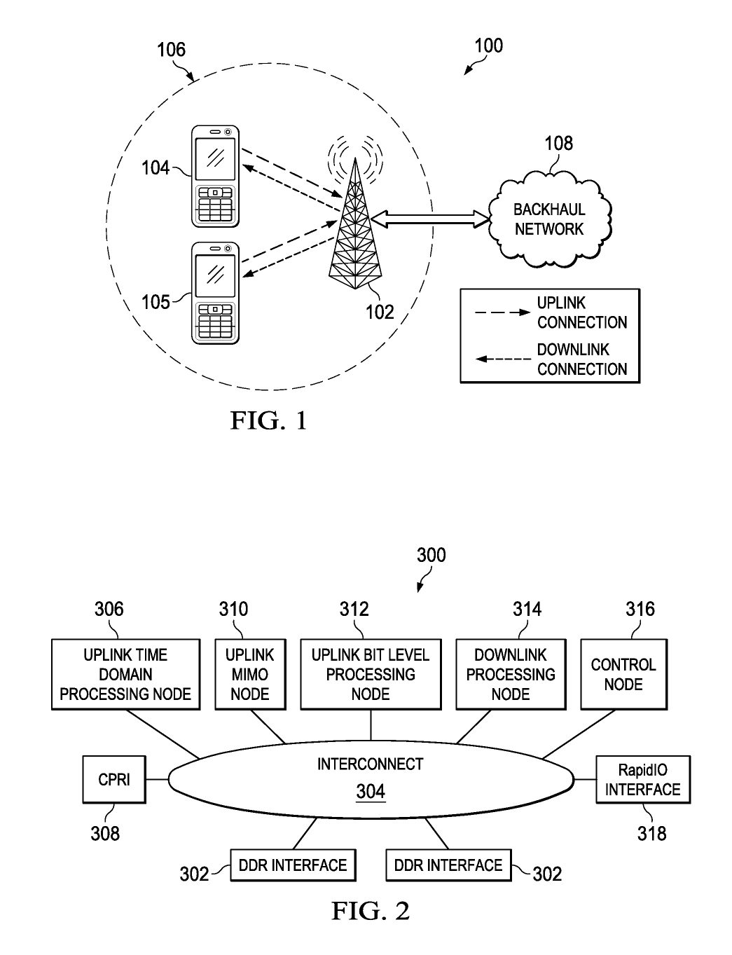

FIG. 1 illustrates network 100 for communicating data. Network 100 includes communications controller 102 having a coverage area 106, a plurality of user equipments (UEs), including UE 104 and UE 105, and backhaul network 108. While two UEs are depicted, it is expressly contemplated that many more may be present. Communications controller 102 may be any component capable of providing wireless access by establishing uplink (dashed line) and/or downlink (dotted line) connections with UE 104 and UE 105, such as a base station, a NodeB, an enhanced nodeB (eNB), an access point, a picocell, a femtocell, relay node, and other wirelessly enabled devices. UE 104 and UE 105 may be any component capable of establishing a wireless connection with communications controller 102, such as cell phones, smart phones, tablets, sensors, etc. Backhaul network 108 may be any component or collection of components that allow data to be exchanged between communications controller 102 and a remote end. In some embodiments, the network 100 may include various other wireless devices, such as relays, etc.

Communications controller 102 forms part of a radio access network (RAN), which may include other communications controllers, elements, and/or devices. The communications controller transmits and/or receives wireless signals within a geographic region or area, which may be referred to as a cell. Some embodiments use multiple-input multiple-output (MIMO) technology, with multiple transceivers in each cell.

FIG. 2 illustrates architecture 300 which includes nodes, such as data masters and DDR interfaces 302, which are connected through interconnect 304. The data masters include common public radio interface (CPRI) 308, uplink time domain processing node 306, uplink MIMO node 310, uplink bit level processing node 312, downlink processing node 314, control node 316, and RapidIO interface 318. Uplink reception and downlink transmission may be supported by mapping different functions to different nodes. The data masters may represent IP blocks or other processing units configured to use or process data that can be stored in DDR memory. DDR interfaces 302 provide an interface to a DDR memory, which may be used to store data for use by the data masters. In some embodiments, the data may be associated with long term evolution (LTE) communication, such as hybrid automatic repeat request (HARQ) retransmission data, measurement reports, physical uplink shared channel (PUSCH) HARQ data, and pre-calculated reference signal (RS) sequences for physical random access channel (PRACH) and beamforming covariance matrix and weight vectors. Control information, such as task lists, parameter tables, hardware accelerator (HAC) parameters, and UE information tables, may be stored in DDR memory. DDR interfaces 302, which are logical DDR interfaces, may include different types of DDR interfaces, such as a HARQ DDR interface or RS sequence DDR interfaces. DDR interfaces 302 may be physically located in one physical DDR interface.

Data in DDR memory, such as data arrays, buffers, and tables, may be moved around the system in bulk, moving between processing and storage. For the physical (PHY) layer, the data is generally not changed, or changed relatively infrequently, and the data will be read out of memory the same as it is written into memory. The total amount of data stored may be large, and the stored data may have the same or a similar type of data structure. For example, the data may be separated by UE. There may be few or no real-time requirements, as every time the memory is accessed, only a small part of the data is examined, either in an event driven manner by a request or on a schedule, for example periodically. When the data is fetched by a request, it may be known in advance when the data will be needed. For example, through MAC/RRC, the UE which will need data in the next several subframes may be known.

Data in DDR memory may be stored in data blocks, such as data arrays, buffers, and tables, which come in different sizes and are stored as a unit in memory by a semantics aware storage, which may be known as a data warehouse management system. Each data block has a tracking identifier which is used for retrieval. The tracking identifier may be, in some embodiments, a number or a tag. The time to output data form the DDR memory may be predictable, for example by a request from an IP block, periodically in accordance with a schedule, or in response to another trigger condition, such as back pressure, or a lack of space in the memory to store newly received data. The data may be pre-arranged and output in advance. For example, the data from different users may be packed, arranged, or assembled in advance, and the pre-arranged data may be delivered to the destination, for example an IP block or software application, in advance or at a designated time. Because the data is pre-arranged in on-chip memory by the semantics aware storage, there are limited interactions between the DDR memory module and other clusters of processors or HACs, and with a low delay for accessing the data, which may increase efficiency.

DDR memory may be used in a semantics aware storage. In an embodiment DDR memory, data is stored in boxes on columns, where each column represents one of the subframes in a HARQ communications. The columns are arranged by rows, where each row represents data for one UE. Boxes may be allocated, freed, and/or rewritten. The subframes of the columns may be a linked list. The data may include metadata to maintain the relationship between the data in each column.

Because upload HARQ is synchronous, the redundancy version (RV) data may be packed in advanced and output in a synchronized data. When data is retransmitted, all of the RV data may be retained, or only the combined data is retained. When all of the RV data is retained, the data from all redundancy versions will be used for HARQ combination and decoding, for example incremental redundancy. That is, every time the HARQ data is requested from the DDR memory, all of the RV data stored will be output. On the other hand, when only the combined data is retained, only the combined data is retained in the DDR memory when there is a retransmission, for example chase combining or incremental redundancy.

HARQ DDR memories may be divided into eight memory blocks, where a memory block corresponds to a subframe of HARQ data. A memory block may include multiple smaller buffers, which may have the same size. When the data is written to the DDR module, the semantics aware storage determines the number of buffers to allocate to each user, determine where to put the data in DDR memory, and create a user table based on the allocations. In one example, the number of allocated buffers and the word count for each user are stored, and may be used to find the stored data location. In another example, the start number of the buffer and the word count are stored, and may be used to find the stored data location.

An embodiment SoC architecture is flexible and configurable. An embodiment RAN SoC architecture may implement a wide variety of wireless RAN functionality while being highly scalable. In an embodiment, programmable and non-programmable compute engines in a RAN SoC are handled similarly or the same. An embodiment using synchronized flow tables with tags which identify data flows.

In a RAN-like database, there are many users, some of whom are inactive, and many tables, with many compute engines accessing the data. A RAN SoC has latency constraints, and operates in real time. In an embodiment, a RAN SoC is viewed as a network of autonomic compute engines which are stitched together into a system using semantics aware storage and an SoC-level scheduler. In semantics aware storage, the memory locations are not addressable, but are assigned identities or tags. The identities are used to store and retrieve the data. The tag is stored and retrieved separately. A network of autonomic compute engines is configured and managed by a logically centralized controller, which is logically centralized, but may be physically distributed. The controller includes hardware and software combinations for runtime management of configured changes and exception conditions backed by a system compilation infrastructure.

In an embodiment, the computation data path is made up of autonomic components. An embodiment behaves similarly to or the same as DSPs and HACs. The compute module may be in a slave role, where the data flow is autonomic based on a controller. In an embodiment, a RAN SoC is viewed as a network of autonomic compute engines which are stitched together into a system using semantics aware storage and a SoC level scheduler. The network of autonomic compute engines is configured and managed by a logically centralized controller. An embodiment uses semantics aware storage and on-the-fly data reorganization to utilize compute engines efficiently. An embodiment uses many DSPs or CPUs with simple and/or small pipelines. An embodiment sends small job packets of fully or partially decoded instructions to perform simple jobs. In an embodiment, compute engines react autonomically to job and data queues.

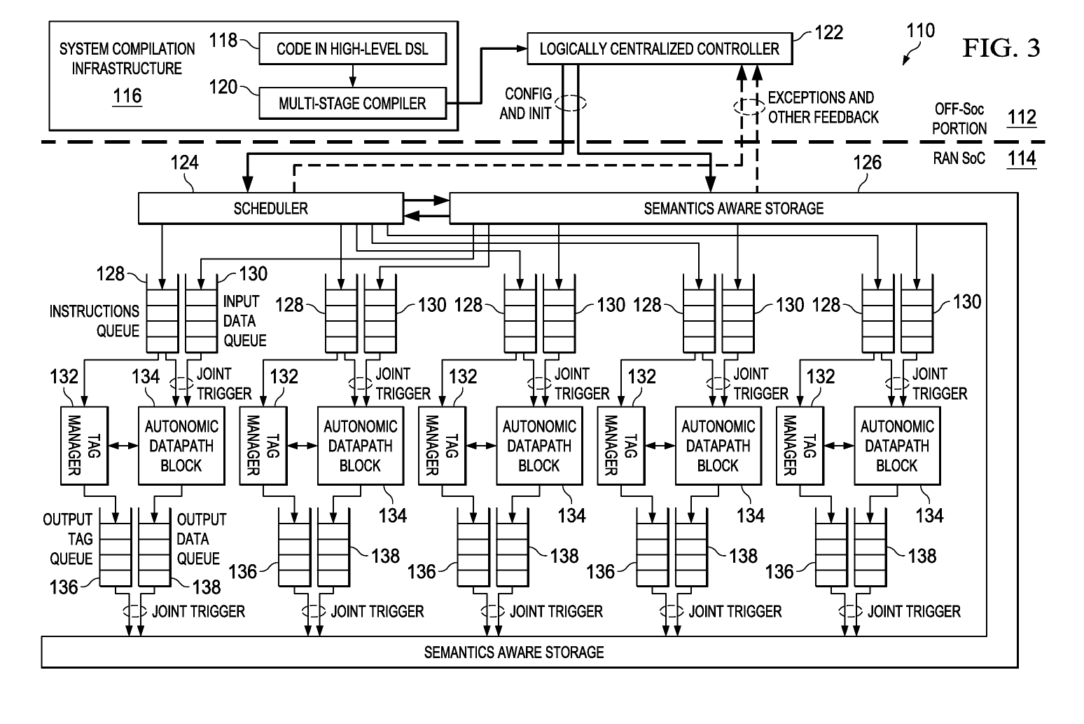

FIG. 3 illustrates RAN SoC architecture 110, which includes RAN SoC 114 and off-SoC system 112. Off-SoC system 112 includes system compilation infrastructure 116, which may be implemented as software. System compilation infrastructure 116 includes code in high level domain specific language (DSL) 118 and multi-stage compiler 120. Multi-stage compiler 120 compiles code in high level DSL 118, and outputs the compiled code to logically centralized controller 122.

Off-SoC system 112 also includes logically centralized controller 122, which includes hardware and software. System compilation infrastructure 116 also initiates logically centralized controller 122, which interacts with RAN SoC 114. In one example, logically centralized controller 122 and RAN SoC 114 are disposed on the same substrate. Alternatively, logically centralized controller 122 is disposed on a different substrate from RAN SoC 114.

Logically centralized controller 122 configures and initiates scheduler 124 and semantics aware storage module 126 in RAN SoC 114. Scheduler 124 may be hardware or a combination of hardware and software. Instructions are passed between scheduler 124 and semantics aware storage module 126. Also, identities and stored data are transmitted from scheduler 124 to logically centralized controller 122. Additionally, exceptions are transmitted from semantics aware storage module 126 to logically centralized controller 122. Semantics aware storage module 126 stores data based on metadata, which may correspond to data blocks.

Scheduler 124 places fully or partially decoded instructions in queues (which may be microcode queues) 128 and data in input data queues 130. There are multiple instruction queues and data queues, which may be arranged in pairs. In one example, there is a one-to-one relationship between fully or partially decoded instruction queues and input data queues. Five pairs of fully or partially decoded instruction queues and input data queues are pictured, but fewer or more queues may be used. The instructions in the fully or partially decoded instruction queue are used for storing the data in the corresponding input data queue.

Queue identifier (Qid) or tag manager 132 reads the tags from fully or partially decoded instruction queue 128 to coordinate storage of the data. Fully or partially decoded instruction queue 128 and input data queue 130 are jointly triggered to simultaneously read out data from input data queue 130 and tags from fully or partially decoded instruction queue 128 into autonomic data path block 130, and to read out tags from fully or partially decoded instruction queue 128 to tag manager 132. Autonomic data path block 134 communicates with tag manager 132 to coordinate the arrangement of the tag into output queue ID or tag queue 136 and output data queue 138 to coordinate the storage of the data and tags.

Output tag queue 136 and output data queue 138 are jointly triggered to write the data block into semantics aware storage module 126 based on the corresponding output tag. The tag is also stored separately in semantics aware storage module 126.

Semantics aware storage module 126 knows how to store the data block and tag. Later, the data block and tag may be read out from semantics aware storage module 126 using the tag to locate the corresponding data block. This may be done, for example, by controller 122 triggering scheduler 124 to direct semantics aware storage module 126 to read out the tag and data.

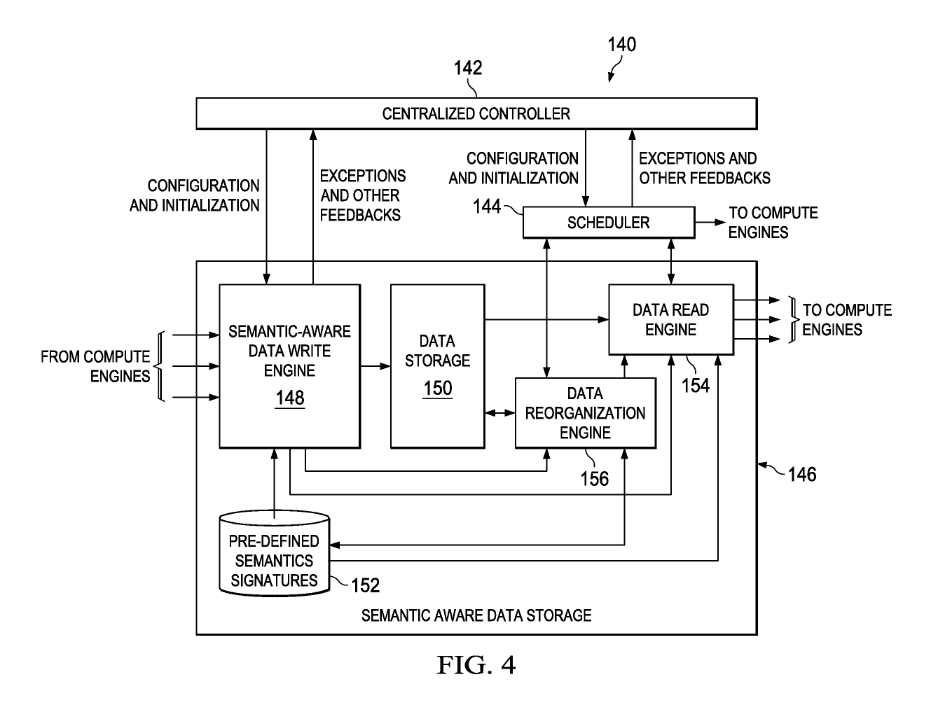

FIG. 4 illustrates semantics aware storage system 140. Logically centralized controller 142, which may be physically distributed, sends configuration and initialization information to scheduler 144.

Scheduler 144 performs scheduling to determine a schedule and outputs the schedule to the compute engines (not pictured). The compute engines may be programmable compute engines, such as DSPs or CPUs, or non-programmable compute engines, such as HACs. In one example, different types of compute engines are treated similarly. In another example, different types of compute engines are treated identically. Scheduler 144 and logically centralized controller 142 communicate with semantics aware data storage module 146.

Semantics aware data storage module 146 contains semantics aware data write engine 148. Logically centralized controller 142 sends configuration and initialization information to semantics aware data write engine 148, which also receives data from the compute engines. Additionally, semantics aware data write engine 148 sends exceptions and other feedback to logically centralized controller 142. Semantics aware data write engine 148 also received semantics signatures from pre-defined semantics signatures 152, and organize blocks of data for storage in semantics aware data storage 146. Data blocks are organized using corresponding tags, which are stored separately, and later used for data block retrieval.

Pre-defined semantics signatures 152 determine semantics signatures in advance. Pre-defined semantics signatures 152 communicate with data reorganization engine 156, which reorganizes data on-the-fly. Data reorganization engine 156 communicates with data storage module 150 to reorganize data. Additionally, data reorganization engine 156 communicates with scheduler 144 and semantics aware data write engine 148. In one example, data reorganization is a pass through. In another example, data reorganization includes the rearrangement, which may include reduction, expansion, or any combination of reduction, expansion, and rearrangement. In reduction, the output data is less than the input data, for example via a subset or a reduction computation, such as accumulation. In expansion, output data is more than the input data, for example via replication and/or insertion of constant or computed values.

Data is stored in data storage module 150. In one example, data storage module 150 contains DDR memory. Data is written by semantics aware data write engine 148, and read out by data read engine 154. Also, data is reorganized by data reorganization engine 156. Tags, which have been stored separately from the data in data storage module 150, are used to read out associated data blocks.

Data is read out of data storage by data read engine 154, which conveys the data to the compute engines. Additionally, data read engine 154 communicates with scheduler 144, semantics aware data write engine 148, and pre-defined semantics signatures 152. Blocks of data are read out of data storage 150 by data read engine 154 using tags.

An embodiment utilizes a systematic and scalable, logically centralized controller, which may be physically distributed. Compute engines, including DSPs, CPUs, and HACs react autonomically to incoming data in their job and data queues. An embodiment involves flexible autonomic data path blocks, which are flexible and performs functions defined via small job packets received via input queues. An embodiment facilitates compute engines with lower complexity of some conventional DSPs or CPUs, or with fewer limitations compared to some conventional HACs. There are multiple flexible data path blocks which may be chained together to form a higher granularity data path. Paths through semantics aware storage may be wires which do not pass through actual storage, and may be reorganized on the fly. Alternatively, paths through semantics aware storage may be thought of as wires which do not pass through actual storage, but may be reorganized on the fly. In an additional example, paths pass through actual storage, and may also be reorganized on the fly. The data path blocks are spatially and temporally flexible to directly match higher granularity computing equations, which may improve computing efficiency. There may be a combination of flexible data path blocks with semantics aware storage and a SoC level scheduler.

An embodiment includes uniform system control including software for programmable compute engines. An embodiment facilitates individual assemblies of autonomic compute engines to be appropriately sized for SoC layout. The SoC may contain the hierarchy of autonomic networks. Semantics aware data storage handles data movement and reorganization, which may avoid wasting compute engine cycles. An embodiment uses an automated system level compilation process that can be driven by framework leveraging domain specific languages. Automation and architecture facilitates system wide quality of service (QoS) guarantees. An embodiment facilitates the automated use of message passing and event driven programming model. An embodiment is flexible and heterogeneous with reasonable overhead.

In an embodiment, off-SoC system compilation infrastructure is in a cloud, with a centralized controller. Virtualized interchangeable assemblies of autonomic compute engines are accessed via a uniform applications programing interface (API).

Embodiments may be implemented in network function virtualization (NFV) boxes, cloud-RAN (C-RAN), distributed C-RAN, or other RAN implementations.

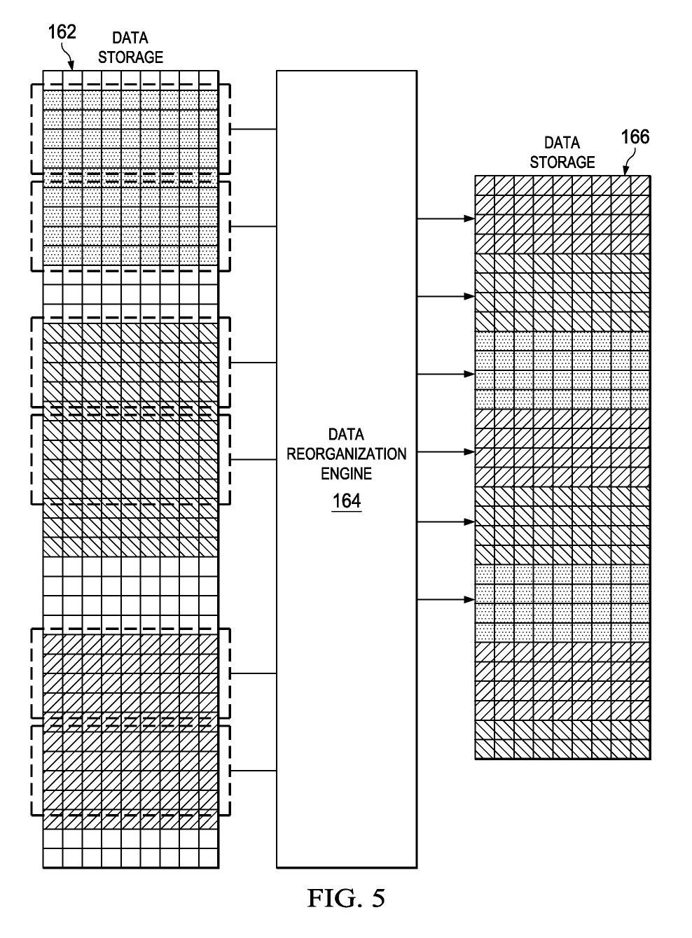

FIG. 5 illustrates an example of on-the-fly data reorganization, for example in baseband physical layer processing. Data in data storage module 162 is reorganized, on-the-fly, by data reorganization engine 164 to produce data storage module 166, with reorganized data. Data storage module 162 shows the original data stored sequentially by the appropriate interface (antenna/common public radio interface (CPRI)), while data storage module 166 shows how data is accessed during processing. The data may be reorganized to make it more convenient to access. When the data is organized, the consumer might not pay the cost associated with accessing the scattered data. Also, many of the access patterns in the baseband physical layer are streaming with strides.

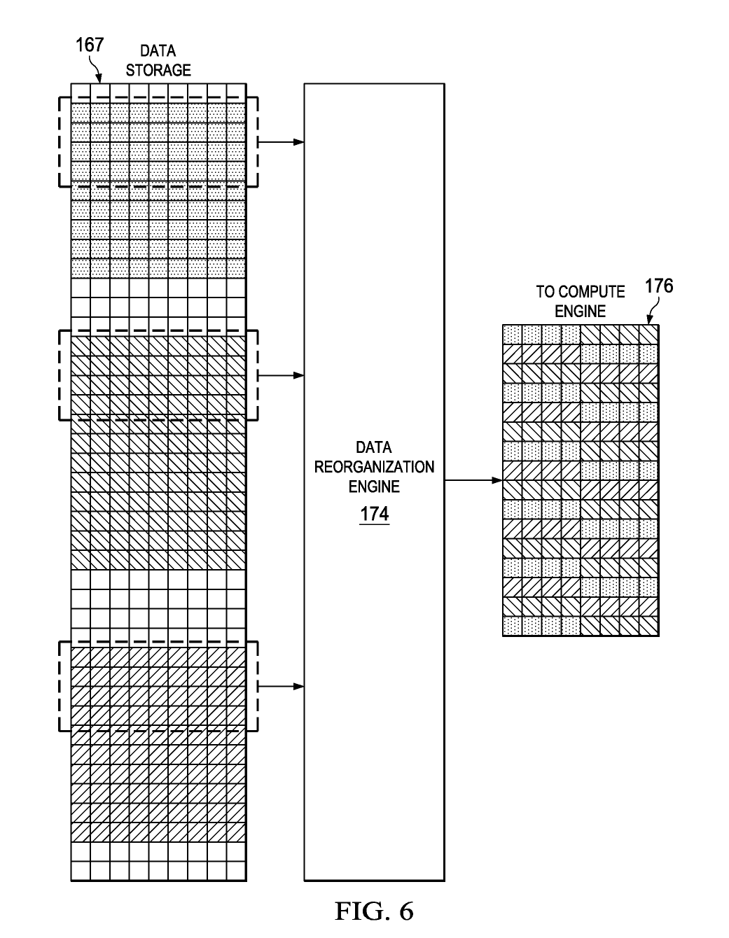

FIG. 6 illustrates another example of on-the-fly data reorganization. The data reorganization engine directly sends the data to the compute engine, instead of creating a subset copy. Data in data storage module 172 is reorganized, on-the-fly, by data reorganization engine 174, and the reorganized data is output to compute engine 176. The data is reorganized to be appropriately consumed by the compute engine. In some examples, data is reorganized, and the reorganized data is directly sent to the compute engine.

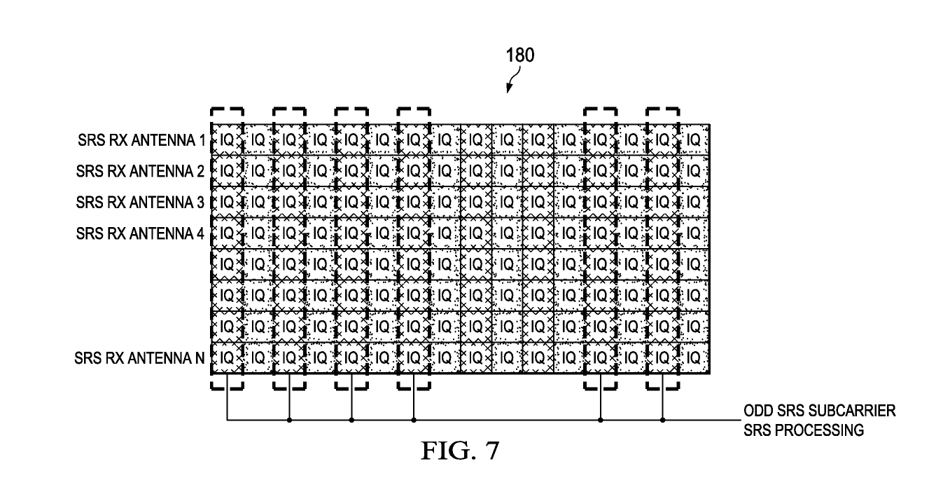

FIG. 7 illustrates data structure 180. Complex control code for accessing the subcarriers in comb-like patterns is implemented in software, along with the signal processing computational tasks. The data access penalties or stalls are in the critical path of the processing latencies. In long term evolution (LTE), a sounding reference signal (SRS) may be used to obtain a wideband estimate of an uplink channel. Code division multiplexing (CDM) facilitates several UEs broadcasting SRS simultaneously on the same time and frequency. SRS may also by separated using frequency division multiplexing (FDM). A UE may broadcast an SRS on every other subcarrier in a single carrier frequency division multiple access (SC-FDMA) scheme in LTE uplink. Because of the orthogonality of the sequences and the frequency division, several UEs may simultaneously broadcast SRS. FDM from the UEs may be split from the SRS symbols for further processing. SRS symbol data is stored in memory in row-major matrix form as SRS[RX_Antenna][SubCarriers]. The number of rows is equal to the number of receive antennas, and the number of columns is equal to the number of subcarriers. For example, a 20 MHz system may have about 1200 subcarriers. SRS symbols from different antennas are combined, and odd SRS symbols may be separated from even SRS symbols.

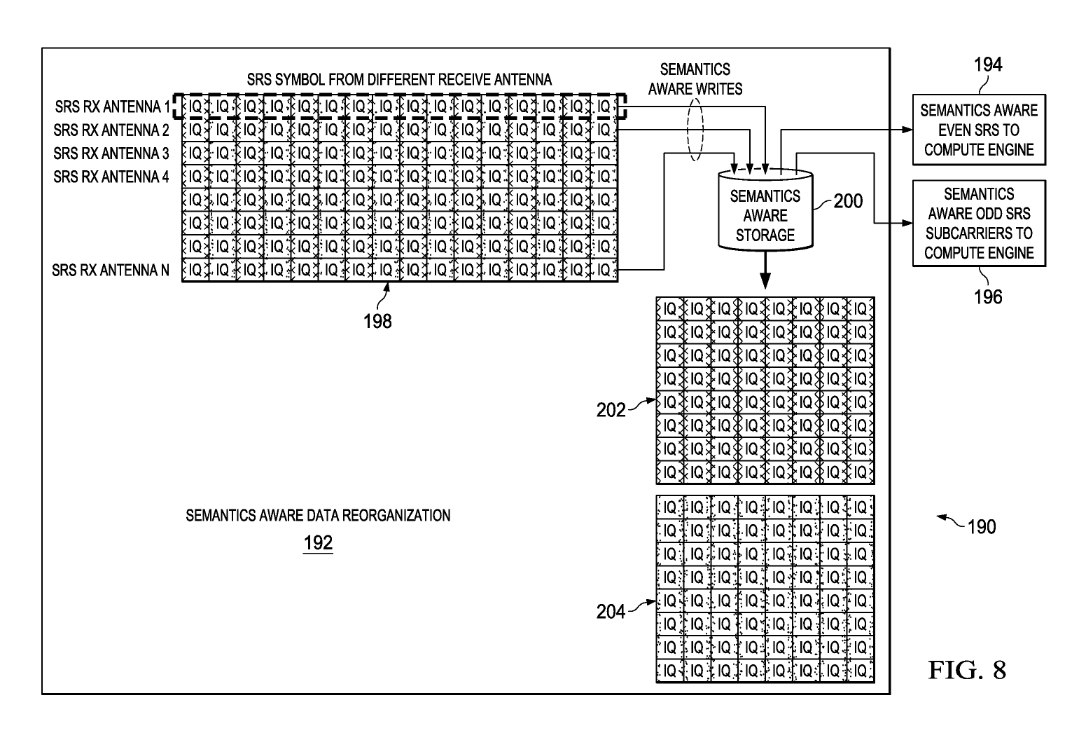

FIG. 8 illustrates data organization with semantics aware storage module 190, an example of data reorganization. In semantics aware data reorganization module 192, data 198 includes SRS symbols from different receive antennas as described in FIG. 7. Semantics aware storage is used to hide complex control software to access odd-only subcarriers or even-only subcarriers. The SRS symbol data arrives from a receive antenna interface at the SoC for storage. With semantic knowledge, such as knowledge of UEs, FDM, or CDM, a semantics-aware storage engine reorganizes the SRS symbols from all receive antennas into compute engines in a data access friendly form. The compute engines perform SRS processing without extracting odd and even subcarriers.

The data is written into semantics aware storage module 200 using semantics aware writes. For example, odd SRS symbols may be stored together, and even SRS symbols stored together. The odd SRS symbols may be separated from the even SRS symbols. This facilitates odd SRS symbols being read out together, and even SRS symbols being read out together.

Data is then stored separately in odd SRS symbols 202 and even SRS symbols 204. Odd SRS symbols 202 are read out to semantics aware odd SRS subcarriers to compute engine 196, while even SRS symbols 204 are read out to semantics aware even SRS to compute engine 194.

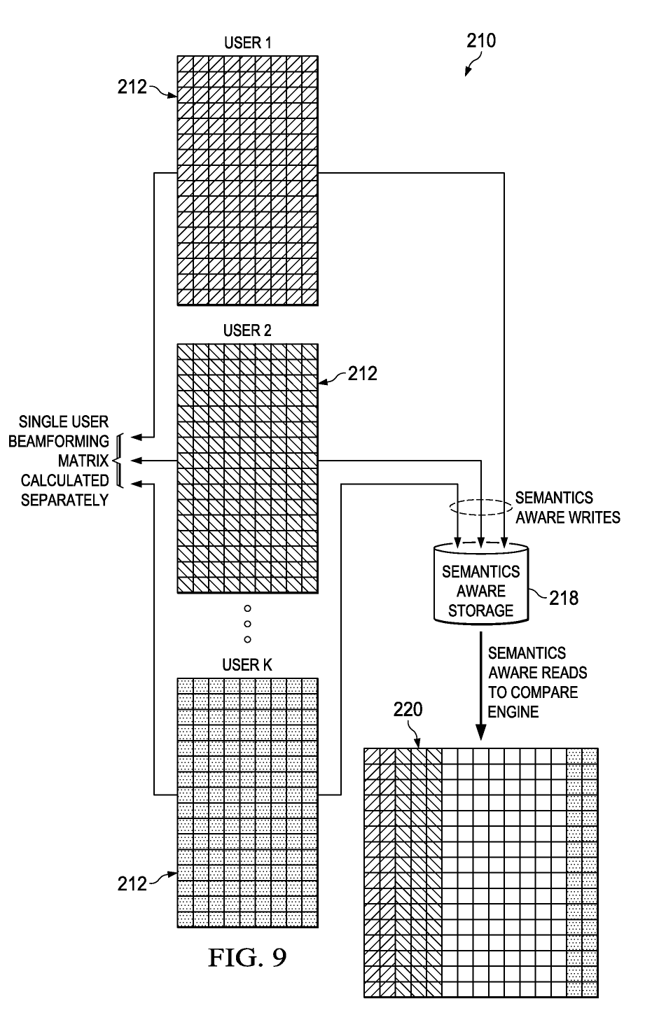

FIG. 9 illustrates data organization flow 210, another example of semantics aware data writes. A single user beamforming matrix is calculated separately from single user beamformings 212. In one example, there are K single user beamformings. A single user beamforming is stored consecutively in memory.

Beamforming weights for each user 212 are stored in semantics aware storage module 218. Then, the data is read out to data 220 using semantics aware reads to compute engines. The data that is selected from each user's beam forming weights that form a multi-user beam forming weights matrix is determined by a set of parameters calculated at runtime. This multi-user beam forming matrix is used to shape the antenna beams (lobes) for this group of users.

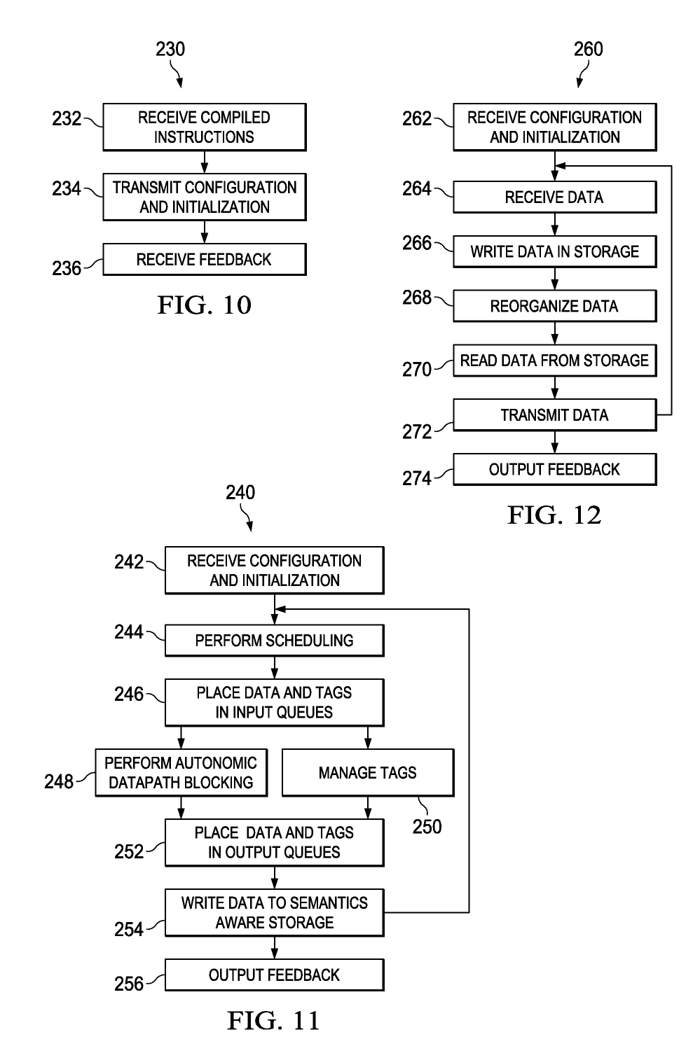

FIG. 10 illustrates flowchart 230 for a method of RAN SoC data storage controlled by a logically centralized controller, which might be physically distributed. The logically centralized controller may include both hardware and software. Initially, in step 232, the logically centralized controller receives compiled instructions from a system compilation infrastructure. The compilation infrastructure may contain code in a high level DSL and a multi-stage compiler. Also, the logically centralized controller determines configuration information in accordance with the compilation instructions.

Next, in step 234, the logically centralized controller transmits configuration and initialization information to the RAN SoC. The logically centralized controller communicates with both a scheduler and a semantics aware data storage module in the RAN SoC. Additionally, the logically centralized controller instructs compute engines on reading and writing data. The logically centralized controller may act as a master to the compute engines. The compute engines may be programmable compute engines, such as DSPs and CPUs, non-programmable compute engines, such as HACs, or may include various types of autonomic compute engines/data path blocks. In one example, different types of compute engines are treated similarly. In another example, different types of compute engines are treated identically.

Also, in step 236, the logically centralized controller receives feedback from the RAN SoC. The logically centralized controller receives exceptions and other feedback from the scheduler and/or the semantics-aware data storage module.

FIG. 11 illustrates flowchart 240 for an embodiment method of RAN SoC data storage performed by a RAN SoC. Initially, in step 242, the RAN SoC receives configuration and initialization information. Step 242 may be performed multiple times, for example based on a schedule, or based on new information. The configuration and initialization information may be received from a logically centralized controller by a scheduler and a semantics aware data storage module.

Next, in step 244, the scheduler performs scheduling. The scheduler also communicates with the semantics aware storage module.

Then, in step 246, data and associated tags are placed in separate input queues. The data is read in from a semantics aware data storage module of the SoC. The scheduler places the tags in fully or partially decoded instruction queues, while the semantics aware storage places the data in input data queues. The fully or partially decoded instruction queues and input data queues may be arranged in pairs, with a tag and the corresponding data block placed in the associated queues.

In step 248, computation is performed by an autonomic data path block. A fully or partially decoded instruction queue and input data queue are jointly triggered to both be read into the autonomic data path block. Meanwhile, in step 250, tags are managed by a tag manager. The tag manager and autonomic data path blocks coordinate with each other to organize the data blocks and tags for storage in the semantics aware storage module. The tags are read out from the fully or partially decoded instruction queue when triggered.

In step 252, data blocks and tags are placed in output queues. Data is placed in an output data queue from the autonomic data path block. Also, tags are placed in the output tag queue from the tag manager.

Then, in step 254, the data blocks and tags are written to the semantics aware storage module. The output tag queue and output data queue are jointly triggered, and the data blocks and tags are stored separately in the semantics aware storage module. In one example, after step 254, the RAN SoC proceeds to step 244 to again perform scheduling, and to step 254 to provide feedback. Alternatively, the RAN SoC proceeds to step 242 to again receive configuration and initialization information.

In step 256, the RAN SoC transmits feedback. Feedback, including exceptions, is transmitted from the scheduler and from the semantics aware storage module to the logically centralized controller. The feedback may occur offline.

FIG. 12 illustrates flowchart 260 for a method of RAN SoC data storage performed by a semantics aware storage module. Initially, in step 262, the semantic aware storage module receives configuration and initialization information from a logically centralized controller and/or a scheduler.

Next, in step 264, a semantics aware data write engine of the semantics aware storage module receives data from compute engines.

Then, in step 266, the semantics aware storage module writes the data from the semantics aware data write engine to the data storage. Pre-defined semantics signatures may be used in writing the data to data storage.

In step 268, data in the data storage is reorganized. This may be performed on-the-fly. To reorganize the data, a data reorganization engine interacts with the data storage, the pre-defined semantics signatures, the semantic aware data write engine, a data read engine, and the external scheduler. In one example, data reorganization is a pass through. In another example, data reorganization includes the rearrangement, which may include reduction, expansion, or any combination of reduction, expansion, and rearrangement. In reduction, the output data is less than the input data, for example via a subset or a reduction computation, such as accumulation. In expansion, output data is more than the input data, for example via replication and/or insertion of constant or computed values.

In step 270, the data is read from the data storage engine, for example by the data read engine. The data read engine communicates with the data reorganization engine, the semantics aware data write engine, the pre-defined semantics signatures, and the externals scheduler.

Then, in step 272, the semantic aware data storage module transmits the data which has been read out from the data storage. The data is transmitted to compute engines. The compute engines may be non-programmable compute engines, such as HACs, and/or programmable compute engines, such as DSPs or CPUs. In one example, after step 272, the RAN SoC returns to step 264 to continue to receive data, and to step 274 to provide feedback. Alternatively, the RAN SoC returns to step 262 to again receive configuration and initialization information.

In step 274, the semantics aware data storage module transmits feedback, including exceptions. The feedback is transmitted to the scheduler and the logically centralized controller. The feedback may be provided offline.

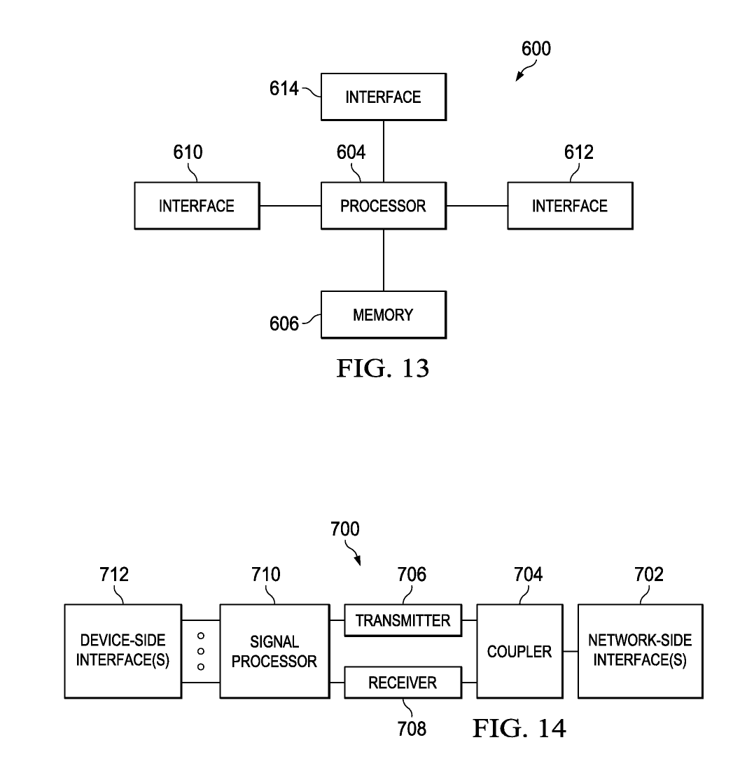

FIG. 13 illustrates a block diagram of an embodiment processing system 600 for performing methods described herein, which may be installed in a host device. As shown, the processing system 600 includes a processor 604, a memory 606, and interfaces 610-614, which may (or may not) be arranged as shown in FIG. 13. The processor 604 may be any component or collection of components adapted to perform computations and/or other processing related tasks, and the memory 606 may be any component or collection of components adapted to store programming and/or instructions for execution by the processor 604. In an embodiment, the memory 606 includes a non-transitory computer readable medium. The interfaces 610, 612, 614 may be any component or collection of components that allow the processing system 600 to communicate with other devices/components and/or a user. For example, one or more of the interfaces 610, 612, 614 may be adapted to communicate data, control, or management messages from the processor 604 to applications installed on the host device and/or a remote device. As another example, one or more of the interfaces 610, 612, 614 may be adapted to allow a user or user device (e.g., personal computer (PC), etc.) to interact/communicate with the processing system 600. The processing system 600 may include additional components not depicted in FIG. 13, such as long term storage (e.g., non-volatile memory, etc.).

In some embodiments, the processing system 600 is included in a network device that is accessing, or part otherwise of, a telecommunications network. In one example, the processing system 600 is in a network-side device in a wireless or wireline telecommunications network, such as a base station, a relay station, a scheduler, a controller, a gateway, a router, an applications server, or any other device in the telecommunications network. In other embodiments, the processing system 600 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 610, 612, 614 connects the processing system 600 to a transceiver adapted to transmit and receive signaling over the telecommunications network. FIG. 14 illustrates a block diagram of a transceiver 700 adapted to transmit and receive signaling over a telecommunications network. The transceiver 700 may be installed in a host device. As shown, the transceiver 700 comprises a network-side interface 702, a coupler 704, a transmitter 706, a receiver 708, a signal processor 710, and a device-side interface 712. The network-side interface 702 may include any component or collection of components adapted to transmit or receive signaling over a wireless or wireline telecommunications network. The coupler 704 may include any component or collection of components adapted to facilitate bi-directional communication over the network-side interface 702. The transmitter 706 may include any component or collection of components (e.g., up-converter, power amplifier, etc.) adapted to convert a baseband signal into a modulated carrier signal suitable for transmission over the network-side interface 702. The receiver 708 may include any component or collection of components (e.g., down-converter, low noise amplifier, etc.) adapted to convert a carrier signal received over the network-side interface 702 into a baseband signal. The signal processor 710 may include any component or collection of components adapted to convert a baseband signal into a data signal suitable for communication over the device-side interface(s) 712, or vice-versa. The device-side interface(s) 712 may include any component or collection of components adapted to communicate data-signals between the signal processor 710 and components within the host device (e.g., the processing system 600, local area network (LAN) ports, etc.).

The transceiver 700 may transmit and receive signaling over any type of communications medium. In some embodiments, the transceiver 700 transmits and receives signaling over a wireless medium. For example, the transceiver 700 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 702 comprises one or more antenna/radiating elements. For example, the network-side interface 702 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 700 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method comprising:
receiving, by a system on a chip (SoC) from a logically centralized controller, configuration information;
reading, from a semantics aware storage module of the SoC, a data block in accordance with the configuration information;
performing scheduling to produce a schedule in accordance with the configuration information;
writing the data block to an input data queue in accordance with the schedule to produce a stored data block; and
writing a tag to an input tag queue to produce a stored tag, wherein the tag corresponds to the data block.

2. The method of claim 1, further comprising:
triggering the input data queue to output the stored data block and the input tag queue to output the stored tag;
managing the data block by an autonomic data path block to produce a managed data block; and
managing the tag by a tag manager to produce a managed tag.

3. The method of claim 2, further comprising:
writing the managed data block to an output data queue to produce an output data block; and
writing the managed tag to an output tag queue to produce an output tag.

4. The method of claim 3, further comprising:
jointly triggering the output data queue to read the output data block to produce a read data block and the output tag queue to read the output tag to produce a read tag;
writing the read data block to the semantics aware storage module; and
writing the read data block to the semantics aware storage module.

5. The method of claim 4, further comprising transmitting, by the SoC to the logically centralized controller, feedback in accordance with writing the read data block.

6. A method comprising:
receiving, by a logically centralized controller from a system compilation infrastructure, compiled instructions;
determining configuration information in accordance with the compiled instructions;
transmitting, by the logically centralized controller to a system on a chip (SoC), the configuration information; and
receiving, by the logically centralized controller, from the SoC, feedback in accordance with the configuration information.

7. The method of claim 6, wherein the logically centralized controller is physically distributed.

8. The method of claim 6, wherein transmitting the configuration information comprises transmitting, by the logically centralized controller to a scheduler, the configuration information, and wherein receiving the feedback comprises receiving, by the logically centralized controller from the scheduler, the feedback.

9. The method of claim 6, wherein transmitting the configuration information comprises transmitting, by the logically centralized controller to a semantics aware storage module, the configuration information, and wherein receiving the feedback comprises receiving, by the logically centralized controller from the semantics aware storage module, the feedback.

10. The method of claim 6, further comprising instructing a compute engine to write data in accordance with the compiled instructions.

11. The method of claim 6, further comprising instructing a compute engine to read data in accordance with the compiled instructions.

12. A system comprising:
a data storage module;
a processor coupled to the data storage module; and
a non-transitory computer readable storage medium storing programming for execution by the processor, the programming including instructions to
receive a first data block from a first compute engine,
determine a first tag corresponding to the first data block,
write the first data block to the data storage module in accordance with the first tag, and
write the first tag to the data storage module.

13. The system of claim 12, wherein the instructions further comprise instructions to:
read, from the data storage module, a second data block in accordance with a second tag, and
transmit, to a second compute engine, the second data block.

14. The system of claim 12, wherein the instructions to determine the first tag further comprise instructions to determine the first tag in accordance with pre-defined semantics signatures.

15. The system of claim 12, wherein the instructions further comprise instructions to communicate with a logically centralized controller.

16. The system of claim 12, wherein the instructions further comprise instructions to communicate with a scheduler.

17. The system of claim 12, wherein the first compute engine is a programmable compute engine.

18. The system of claim 12, wherein the first compute engine is a non-programmable compute engine.

19. A logically centralized controller comprising:
a processor; and
a non-transitory computer readable storage medium storing programming for execution by the processor, the programming including instructions to
receive, from a system compilation infrastructure, compiled instructions,
determine configuration information in accordance with the compiled instructions,
transmit, to a system on a chip (SoC), the configuration information, and
receive, from the SoC, feedback in accordance with the configuration information.

20. The logically centralized controller of claim 19, wherein the instructions to transmit the configurations information comprise instructions to transmit the configuration information to a semantics aware storage module, and wherein the instructions to receive the feedback comprise instructions to receive the feedback from the semantics aware storage module.
